(19) United States
(12) Patent Application Publication
(10) Pub. No.: US 2017/0191621 A1
(43) Pub. Date: Jul. 6, 2017

(54) LIQUID CRYOGEN VAPORIZER METHOD AND SYSTEM

(71) Applicant: Air Liquide Industrial U.S. LP, Houston, TX (US)

(72) Inventors: Charles L. CARISTAN, Houston, TX (US); Frederick Schweighardt, Cypress, TX (US); Nimisha Kaul, Kennesaw, GA (US)

(21) Appl. No.: 15/197,127

(22) Filed: Jun. 29, 2016

Related U.S. Application Data
(63) Continuation-in-part of application No. 14/984,176, filed on Dec. 30, 2015.

(51) Int. Cl. F17C 7/04

(52) U.S. Cl. CPC F17C 7/04

(57) ABSTRACT

A flow of liquid cryogen from a liquid cryogen storage tank is vaporized at a heat exchanger against a flow of air in order to vaporize the liquid cryogen for a point of use and provide a flow of chilled air for use in refrigeration of a space, room or structure. The tank, heat exchanger, point of use, and space, room or structure are all located at a same installation.

### CROSS-REFERENCE TO RELATED APPLICATIONS

This application is a Continuation In Part of U.S. application Ser. No. 14/984,176 filed Dec. 30, 2015, the contents of which are herein incorporated by reference in their entirety.

### BACKGROUND

Field of the Invention

The present invention relates to the supply of industrial gas from vaporizers fed with liquefied gas.

Related Art

Many heating, cooling, freezing, inerting, cutting, shielding, fabricating, oxidation, reduction and curing operations utilize industrial gases. These gases include but are not limited to nitrogen, oxygen, argon, air, hydrogen, helium, and carbon dioxide. For operations consuming large amounts of industrial gas, it is more economical to store the gas in liquefied form. As shown in FIG. 1, a flow of gas 1 for consumption at a point of use (POU) is typically obtained by feeding liquid nitrogen 3 from a storage tank 4 to conventional vaporizer 5. The vaporizer 5 transfers heat from the ambient air 7 surrounding the vaporizer 5 to the liquid cryogen so as to vaporize the liquid cryogen. The flow of the gas 1 results.

Some installations including the above operations may have a need for mechanical refrigeration on-site for cooling of fluids such as air or water. While mechanical refrigeration systems are well-developed technologies, they are not ideal because they can be relatively costly in terms of energy requirements. Also, certain older refrigeration systems may still utilize ozone-destroying refrigerants such as fluorocarbons or toxic refrigerants such as ammonia.

Other installations including cooling or freezing operations may utilize cryogenic refrigeration instead of mechanical refrigeration to cool or freeze any of a wide variety of materials. Because energy is consumed in the production of liquid cryogens, liquid cryogens may be considered as having energy stored within them. For example, in order to produce each ton (907.2 kg) of liquid nitrogen, 600 kWh (2,160 MJ) of energy is required to produce the required liquefaction and cold temperature and/or high pressure. The liquid cryogen has “cold energy” because it may be used to absorb significant amounts of heat. For example, nitrogen has a latent heat of vaporization at 1.013 bar (14.69 psi) at its boiling point of 416.20 BTU/lb (199.18 kJ/kg).

Cryogenic refrigeration works as follows. Heat is transferred from the warmer temperature material to the liquid cryogen either through contact between the material and the liquid cryogen or via a heat exchanger. The liquid cryogen absorbs the heat of vaporization from the material to thereby cool the material and vaporize the liquid cryogen. The vaporized cryogen is subsequently vented. While cryogenic refrigeration systems are also well-developed technologies, they are also not ideal because once the cold energy of the liquid cryogen is consumed, no value is extracted from the resultant gaseous cryogen.

### SUMMARY

It is an object of the invention to provide improve the efficiency of operations that ordinarily utilize on-site mechanical refrigeration. It is also an object of the invention to extract value from gaseous cryogens resulting from the consumption of liquid cryogens in cooling or freezing operations.

There is disclosed a method for supplying a flow of a gaseous cryogen from a source containing the cryogen in liquid form. The method comprises the following steps. A flow of air to a warm side of a heat exchanger located at an installation is allowed. Contemporaneous with said step of allowing a flow of air, a first flow of a liquid cryogen from a liquid cryogen storage tank to a cold side of the heat exchanger is allowed. At the heat exchanger, heat is exchanged between the flow of the liquid cryogen and the flow of air to produce a first flow of vaporized cryogen and a flow of chilled air, respectively. The first flow of vaporized cryogen is used at a point of use that is located at the installation. Refrigeration is provided to a space, room or structure with the flow of cooled air. The space, room or structure and also the liquid cryogen storage tank are located at the installation. There is also disclosed an installation supplied with refrigeration and gaseous cryogen from vaporization of liquid cryogen, comprising: a liquid cryogen storage tank containing liquid cryogen that is located at an installation; a heat exchanger having a cold side in fluid communication with said storage tank and a warm side receiving a flow of air, said heat exchanger being located at the installation, said heat exchanger being adapted and configured to exchange heat between a flow of the liquid cryogen from the storage tank on the cold side and the flow of air on the warm side to produce a first flow of vaporized cryogen and a flow of chilled air, respectively; a point of use, located at the installation, that is adapted and configured to us the first flow of vaporized cryogen; and a space, room or structure located at the installation that is refrigerated with the flow of cooled air.

The method and/or installation may include one or more of the following aspects:
a second flow of the liquid cryogen from the liquid cryogen storage tank to a vaporizer is allowed; heat is exchanged, at the heat exchanger, between the second flow of the liquid cryogen and ambient air surrounding the vaporizer to produce a second flow of vaporized cryogen; the first flow of vaporized cryogen is fed to an inlet of a compressor where it is compressed, the compressor being disposed in fluid communication between the heat exchanger and the point of use; a flow of the first flow of vaporized cryogen from an outlet of the compressor to a buffer tank is allowed, the buffer tank being disposed in fluid communication between the compressor and the point of use, wherein the point of use receives the first flow of vaporized cryogen from the buffer tank; the second flow of vaporized cryogen is used at the point of use, wherein: when a demand for the vaporized cryogen by the point of use does not exceed a nominal flow rate, the gaseous cryogen of the first flow is accumulated in the buffer tank and is not used by the point of use, and when a demand for the vaporized cryogen by the point of use exceeds a nominal flow rate, the first flow of the gaseous cryogen from the buffer tank is used by the point of use.
refrigeration is provided to the space, room or structure using a mechanical refrigeration unit located at the installation.
the heat exchanger is disposed within the space, room or structure.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic view of vaporization of a liquid cryogen using a Prior Art liquid cryogen vaporizer.

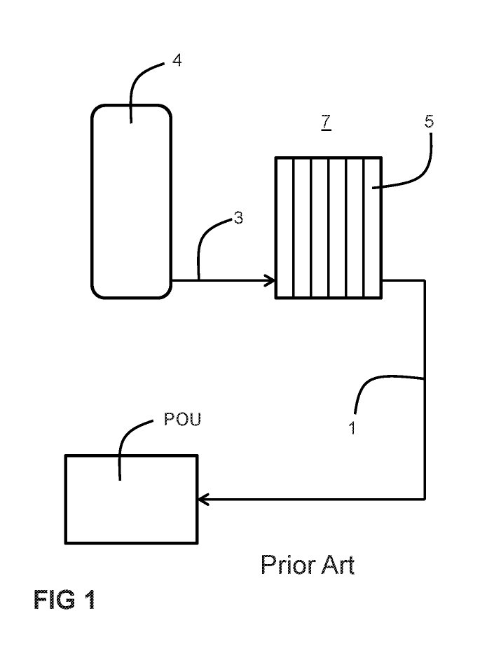

FIG. 2 is a schematic view of the liquid cryogen vaporization system and process of the invention.

FIG. 3 is a schematic view of a refinement of the liquid cryogen vaporization system and process of FIG. 2, including a compressor, buffer tank and point of use.

FIG. 4 is a schematic view of an embodiment of the liquid cryogen vaporization system and process of the invention, including a blower and a refrigerated space.

FIG. 5 is a schematic view of a refinement of the liquid cryogen vaporization system and process of FIG. 4, including a compressor, buffer tank and point of use.

FIG. 6 is a schematic view of another embodiment of the liquid cryogen vaporization system and process of the invention, including a blower where the vaporizer is disposed within a refrigerated space.

FIG. 7 is a schematic view of a refinement of the liquid cryogen vaporization system and process of FIG. 6, including a compressor, buffer tank and point of use.

### DESCRIPTION OF PREFERRED EMBODIMENTS

At conventional vaporizers, some of the cold energy stored in the liquid cryogen is wasted when it is vaporized using the heat of the ambient air around the vaporizer. In order to appreciate the scale of the energy loss, it may be estimated that up to 37 million kWh/day of stored energy is lost in the US through vaporization of liquid argon, liquid nitrogen and liquid oxygen using conventional vaporizers.

The invention provides a way to avoid or reduce the loss of that stored cold energy.

A heat exchanger is used to exchange heat between a stream of colder temperature liquid cryogen (to be vaporized) and a stream of warmer temperature air (to be cooled). The sensible heat of the air provides the necessary latent heat for vaporization of the liquid cryogen. As a result of this heat exchange, the air is cooled. One of ordinary skill in the art will recognize that the temperature of the chilled air will depend upon the flow rates and temperatures of the air to be cooled and the liquid cryogen to be vaporized and also the efficiency of the heat exchanger. In contrast to conventional vaporizers where the cooled ambient air surrounding the vaporizer is put to no use, the air to be cooled in the invention is used for providing chilled air to cool a room or structure or space.

The capacity of the liquid cryogen storage tank may be selected to suit the flow rates required by the point of use (or means for using gaseous cryogen) and the desired frequency of refilling the tank. The piping between the liquid cryogen storage tank and the vaporizer is insulated in order to avoid losses of cold energy caused by heat leaks. Typically, the piping is vacuum jacketed or foam insulated.

The capacity of the heat exchanger is driven by the flow rate required by the point of use (or means for using gaseous cryogen). The configuration of the heat exchanger is not limited. Different types of heat exchangers include: shell and tube, plate, plate and shell, plate fin, pillow fin, and coil. Typically, the heat exchanger is a coiled metal tube enclosed within a housing where the liquid cryogen flows through the tube and the air to be cooled flows in between the outer surface of the coiled metal tube and the inner surface of the housing. A particularly suitable heat exchanger may be obtained from Air Liquide under the trade name Blueeze.

The diameter of the piping between the heat exchanger and the point of use (or means for using gaseous cryogen) should be sized so that the pressure drop associated with the piping does not exceed the difference between the pressure of the gaseous cryogen in the heat exchanger and the pressure of the gaseous cryogen at the point of use (or means for using gaseous cryogen). Otherwise, no pressure differential would exist to cause a flow of the gaseous cryogen to the point of use (or means for using gaseous cryogen).

Depending upon the pressure of the gaseous cryogen required at the point of use (or means for using gaseous cryogen) (especially) and/or the pressure drop associated with the piping between the heat exchanger and the point of use (or means for using gaseous cryogen), after vaporization of the liquid cryogen at the heat exchanger, the now-gaseous cryogen may optionally be compressed in a compressor. The power of the compressor may be selected to suit the flow rates and pressures required by the point of use (or means for using gaseous cryogen). The stream of liquid cryogen may be fed to the heat exchanger at the demand of the point of use (or means for using gaseous cryogen) in order to provide the required flow rate of gaseous cryogen regardless of whether the gaseous cryogen is compressed downstream of the heat exchanger.

Optionally, the compressed gaseous cryogen may be stored in a buffer tank. Such a buffer tank will allow for the maintenance of a more uniform pressure. Storage in the buffer tank may also be useful for points of use having a wide variation in the consumption of gaseous cryogen over time. Instead of being vaporized on demand and having to size the heat exchanger and compressor to suit the instantaneous flow rate of gaseous cryogen that might be required, the compressed gaseous cryogen may be stored in a buffer tank. Storage in a buffer tank will allow the build-up of a reserve supply of gaseous cryogen when the instantaneous flow rate of gaseous cryogen required by the point of use (or means for using gaseous cryogen) would otherwise overwhelm the size of the heat exchanger and the power of the compressor. This is especially helpful when the need for refrigeration is more or less continuous but the need for gaseous cryogen is on a batch-wise basis.

The pressure limit and capacity of the buffer tank and the power of the compressor may be selected to suit the flow rates and pressures required by the point of use (or means for using gaseous cryogen). Typically, the buffer tank is designed to safely withstand a pressure of at least 200 psig (13.8 barg), at least 500 psig (34.4 barg), or even at least 1,000 psig (68.9 barg).

In practice of the invention, there is a wide variety of different uses (i.e., the point of use (or means for using gaseous cryogen) or means for using gaseous cryogen) for the vaporized cryogen. Non-limiting examples of onsite uses at the installation include: assist gas for cutting or joining materials; shielding gas for cutting or joining materials; inerting or blanketing gas; autoclave curing of composites, gas for controlled atmospheres in heat or cryogenic treatment of materials, packaging gas for products such as foodstuffs, beverages, pharmaceuticals, medical devices; gas for cooling foodstuffs; oxidizing gas for promoting the growth of aerobic microbiological cultures; stripping gas for stripping gases from microbiological cultures; gas for carbonating beverages; oxidizing gas for burners; reducing gas for controlling redox in a reactor, and fuel gas for combustion or reforming processes. There is also a wide variety of different liquid cryogens that may vaporized by the invention. Non-limiting examples include liquid nitrogen, liquid oxygen, liquid argon, liquid air (a mixture of liquid nitrogen and liquid oxygen), liquid hydrogen, liquid helium, liquid carbon dioxide, and liquefied natural gas.

A number of embodiments will now be described.

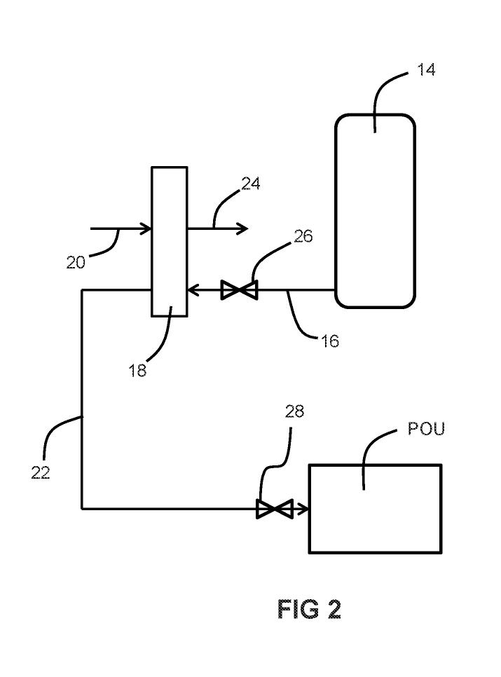

In one embodiment and as best illustrated in FIG. 2, a stream of liquid cryogen 16 is withdrawn from a liquid cryogen storage tank 14 and introduced into a heat exchanger 18. A flow of warmer temperature air 20 is directed across the heat exchanger 18. Sensible heat from the warmer temperature air 20 is transferred via the heat exchanger 18 to the liquid cryogen where it provides the necessary amount of latent heat for vaporization of the liquid cryogen. As a result of this heat transfer, a flow of gaseous cryogen 22 to the point of use POU and a flow of chilled air 24 are yielded. Working in conjunction with one another and at a command of one or more controllers, valves 26, 28 are operable to control the flow rate of the liquid cryogen 16 fed to the heat exchanger 17 and the flow rate of the gaseous cryogen 22 to the point of use POU.

In the embodiment of FIG. 2 and all ensuing embodiments, while the one or more controllers typically consists of a single controller, it may consist of two or more controllers. Also, the piping containing the stream of liquid cryogen 16 may be vacuum jacketed piping to inhibit cold energy losses through heat leaks. On the other hand, the piping containing the flow of chilled air 24 may be made of foam insulated PVC pipe, metal pipes, or metal ducting. Because the temperature of the flow of chilled air 24 is significantly higher than that of the stream of liquid cryogen 16, the piping containing the flow of chilled air 24 need not be jacket-insulated. Significant savings may be realized by selecting foam insulated PVC pipe, metal pipes, or metal ducting for containing the flow of chilled air 24 instead of using vacuum-jacketed piping.

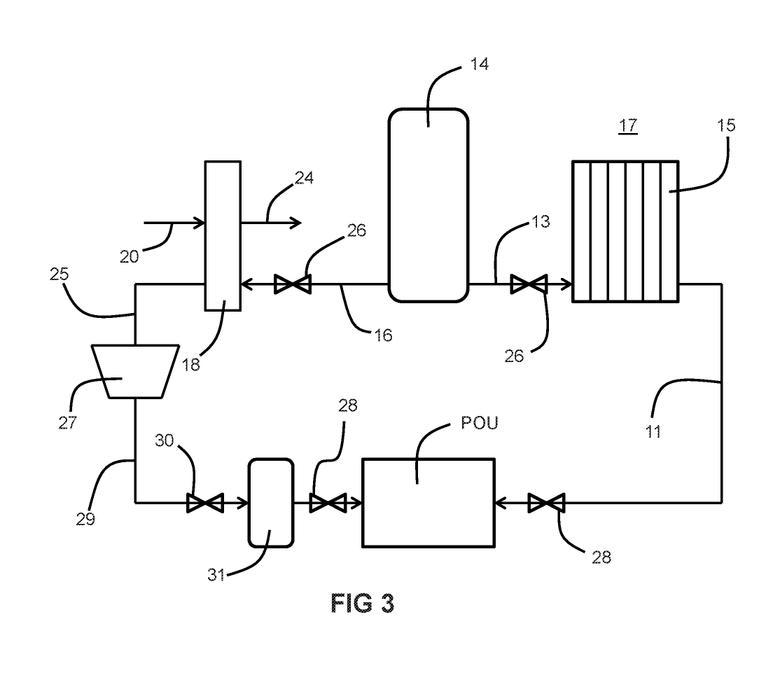

In a refinement of the embodiment of FIG. 2 and as best shown in FIG. 3, the invention is used in conjunction with a conventional vaporization scheme. Liquid cryogen 13 is withdrawn from storage tank 14 and fed to a conventional vaporizer 15. Sensible heat from the ambient air 19 is transferred via the conventional vaporizer 15 to the liquid cryogen where it provides the necessary amount of latent heat for vaporization of the liquid cryogen. As a result of this heat transfer, an additional flow of gaseous cryogen 11 to the point of use POU is yielded. Working in conjunction with one another, valves 17, 21 are operable to control the flow rate of the liquid cryogen 13 fed to the vaporizer 15 and the flow rate of the gaseous cryogen 11 to the point of use POU, respectively.

Liquid cryogen 16 is also withdrawn from storage tank 14 and fed to heat exchanger 18. A flow of warmer temperature air 20 is directed across the heat exchanger 18. Sensible heat from the warmer temperature air 20 is transferred via the heat exchanger 18 to the liquid cryogen where it provides the necessary amount of latent heat for vaporization of the liquid cryogen. As a result of this heat transfer, a flow of gaseous cryogen 25 and the flow of chilled air 24 are yielded. The flow of gaseous cryogen 25 is compressed at a compressor 27. The resultant higher pressure flow of gaseous cryogen 29 is fed to a buffer tank 31. Working in conjunction with one another, valves 26, 30, 28 are operable to control the flow rate of the liquid cryogen 16 fed to the heat exchanger 17, the flow rate of the compressed gaseous cryogen 22 to the buffer tank 31 and the flow rate of the gaseous cryogen 33 to the point of use POU, respectively.

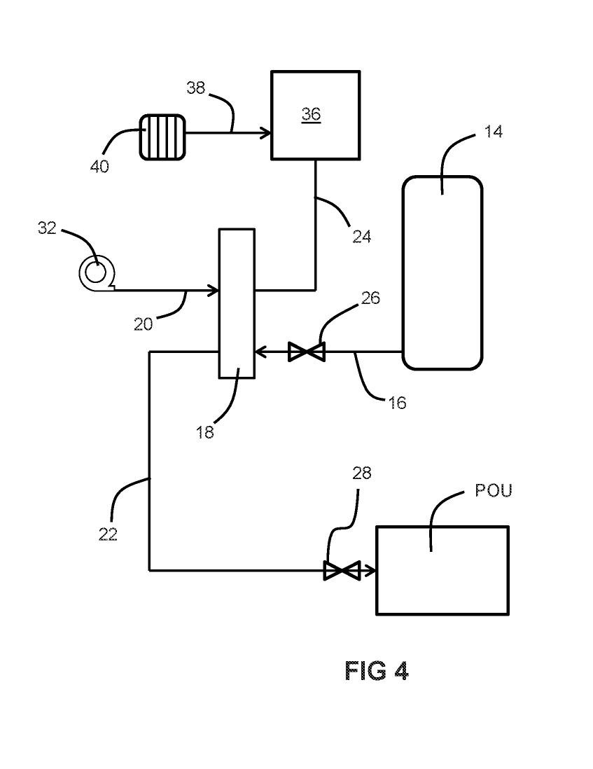

In another embodiment and as best illustrated in FIG. 4, a stream of liquid cryogen 16 is withdrawn from a liquid cryogen storage tank 14 and introduced into a heat exchanger 18. A flow of warmer temperature air 20 from a blower 32 is directed across the heat exchanger 18. Sensible heat from the warmer temperature air 20 is transferred via the heat exchanger 18 to the liquid cryogen where it provides the necessary amount of latent heat for vaporization of the liquid cryogen. As a result of this heat transfer, a flow of gaseous cryogen 22 to the point of use POU and a flow of chilled air 24 are yielded. Working in conjunction with one another, valves 26, 28 are operable to control the flow rate of the liquid cryogen 16 fed to the heat exchanger 17 and the flow rate of the gaseous cryogen 22 to the point of use POU. In order to supply refrigeration, the flow of chilled air 24 is directed to a room, structure or space 36. In this embodiment, the invention is used to back-up a flow of chilled air 38 from a mechanical refrigeration apparatus 40. In this embodiment, the invention may also be used to supplement the refrigeration supplied by apparatus 40, such as when the heat load temporarily exceeds the nominal heat load that is ordinarily satisfied by apparatus 40.

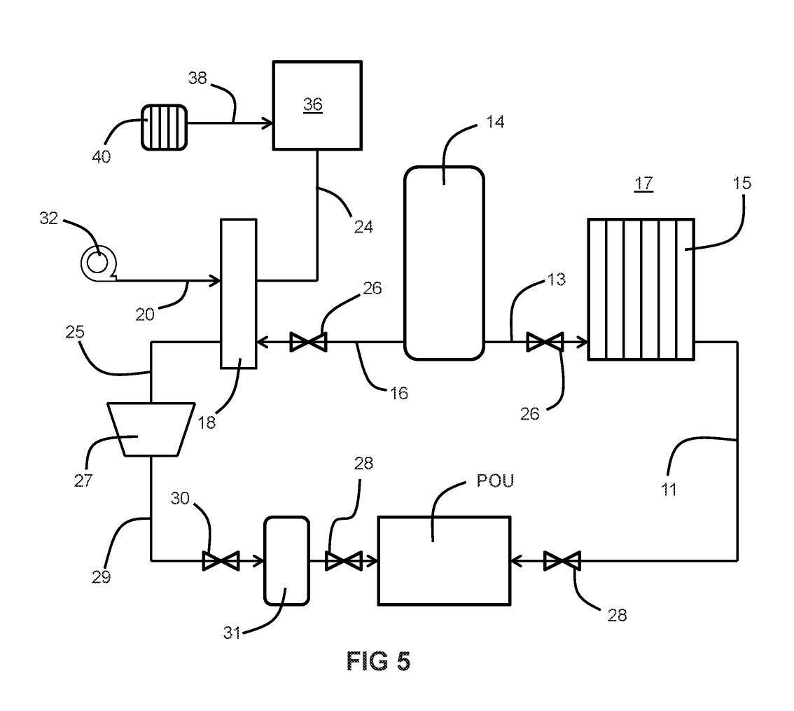

In a refinement of the embodiment of FIG. 4 and as best shown in FIG. 5, the invention is used in conjunction with a conventional vaporization scheme. Liquid cryogen 13 is withdrawn from storage tank 14 and fed to a conventional vaporizer 15. Sensible heat from the ambient air 19 is transferred via the conventional vaporizer 15 to the liquid cryogen where it provides the necessary amount of latent heat for vaporization of the liquid cryogen. As a result of this heat transfer, an additional flow of gaseous cryogen 11 to the point of use POU is yielded. Working in conjunction with one another, valves 17, 21 are operable to control the flow rate of the liquid cryogen 13 fed to the vaporizer 15 and the flow rate of the gaseous cryogen 11 to the point of use POU, respectively.

Liquid cryogen 16 is also withdrawn from a liquid cryogen storage tank 14 and introduced into a heat exchanger 18. A flow of warmer temperature air 20 from a blower 32 is directed across the heat exchanger 18. Sensible heat from the warmer temperature air 20 is transferred via the heat exchanger 18 to the liquid cryogen where it provides the necessary amount of latent heat for vaporization of the liquid cryogen. As a result of this heat transfer, a flow of gaseous cryogen 22 to the point of use POU and a flow of chilled air 24 are yielded. Working in conjunction with one another, valves 26, 28 are operable to control the flow rate of the liquid cryogen 16 fed to the heat exchanger 17 and the flow rate of the gaseous cryogen 22 to the point of use POU. In order to supply refrigeration, the flow of chilled air 24 is directed to a room, structure or space 36. In this embodiment, the invention is used to back-up a flow of chilled air 38 from a mechanical refrigeration apparatus 40. In this embodiment, the invention may also be used to supplement the refrigeration supplied by apparatus 40, such as when the heat load temporarily exceeds the nominal heat load that is ordinarily satisfied by apparatus 40.

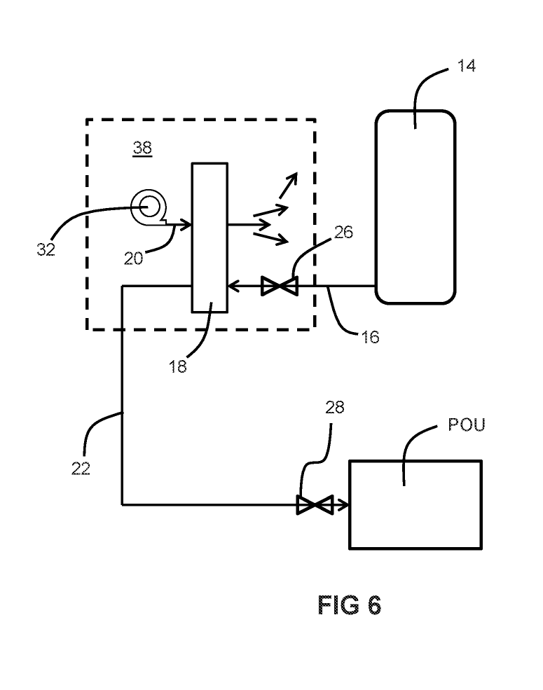

In another embodiment and as best illustrated in FIG. 6, the heat exchanger 18 is located within a refrigerated space, room or structure 38. Liquid cryogen 16 is withdrawn from a liquid cryogen storage tank 14 and introduced into heat exchanger 18 located within refrigerated space, room or structure 38. A blower 32 blows air (from within the refrigerated space, room or structure 38) across the heat exchanger 18 so as to circulate chilled air throughout the refrigerated space, room or structure. The sensible heat from the air blown by the blower is transferred via the heat exchanger 18 to the liquid cryogen where it provides the necessary amount of latent heat for vaporization of the liquid cryogen. As a result of this heat transfer, a flow of gaseous cryogen 22 to the point of use POU and refrigerated air are yielded. Working in conjunction with one another, valves 26, 28 are operable to control the flow rate of the liquid cryogen 16 fed to the heat exchanger 17 and the flow rate of the gaseous cryogen 22 to the point of use POU.

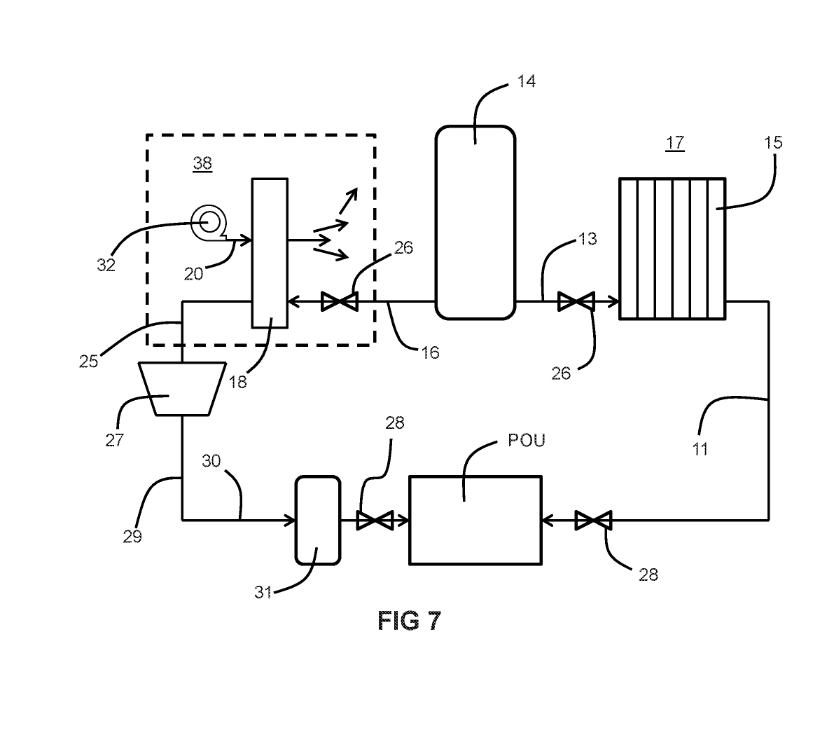

In a refinement of the embodiment of FIG. 6 and as best shown in FIG. 7, the invention is used in conjunction with a conventional vaporization scheme. Liquid cryogen 13 is withdrawn from storage tank 14 and fed to a conventional vaporizer 15. Sensible heat from the ambient air 19 is transferred via the conventional vaporizer 15 to the liquid cryogen where it provides the necessary amount of latent heat for vaporization of the liquid cryogen. As a result of this heat transfer, an additional flow of gaseous cryogen 11 to the point of use POU is yielded. Working in conjunction with one another, valves 17, 21 are operable to control the flow rate of the liquid cryogen 13 fed to the vaporizer 15 and the flow rate of the gaseous cryogen 11 to the point of use POU, respectively.

Liquid cryogen 16 is also withdrawn from a liquid cryogen storage tank 14 and introduced into heat exchanger 18 located within refrigerated space, room or structure 38. A blower 32 blows air (from within the refrigerated space, room or structure 38) across the heat exchanger 18 so as to circulate chilled air throughout the refrigerated space, room or structure. The sensible heat from the air blown by the blower is transferred via the heat exchanger 18 to the liquid cryogen where it provides the necessary amount of latent heat for vaporization of the liquid cryogen. As a result of this heat transfer, a flow of gaseous cryogen 22 to the point of use POU and refrigerated air are yielded. Working in conjunction with one another, valves 26, 28 are operable to control the flow rate of the liquid cryogen 16 fed to the heat exchanger 17 and the flow rate of the gaseous cryogen 22 to the point of use POU.

Any of the embodiments of the invention are particular applicable to a point of use (or means for using gaseous cryogen) comprising cold storage of polymer-impregnated inorganic fiber articles (“prepregs”) and inert curing of prepregs. Prepregs are composites made up of inorganic fibers (such as carbon fibers) that are impregnated with a thermosetting polymer that may be cured (i.e. cross-linked). The fibers may oriented, such as woven fabrics or tows, or non-oriented such as non-woven fabrics. The prepreg has some degree of flexibility, but curing imparts rigidity. Typically, the prepregs are cured within a heated mold.

Prepregs must be handled with care, both before and during curing, because of two separate problems. First, premature curing of the prepreg before its final shape/configuration has been imparted (such as in a heated mold) is undesirable, because as curing progresses, the prepreg loses significant flexibility and tackiness and gains rigidity. Rigid prepregs may be difficult or impossible to shape or mold. Since premature curing is related to storage temperature, prepreg storage temperatures play an important role in their shelf life. Indeed, the material handling, storage, and “out-time” tracking are the most common findings during audits of composite companies and literally tons of prepreg material is wasted each year due to shelf life expiration. Second, at the relatively high temperatures associated with heated molds for curing prepregs, the carbon fibers may combust with oxygen present in the ambient air within the autoclave that encloses the curing mold.

Implementation of the invention may address each of these problems.

First, at least some of the refrigeration needs associated with storage of the uncured prepregs may be satisfied by the chilled air produced by the invention. This refrigeration (in the form of chilled air) may be supplied by the invention instead of the refrigeration ordinarily supplied by mechanical refrigeration units. Alternatively, the refrigeration supplied by the invention may supplement the refrigeration supplied by mechanical refrigeration units located at the installation. For example, during periods of low load, such as when the refrigerated storage containers are left closed, any required refrigeration may be supplied by the invention and also by mechanical refrigeration units operated at relatively lower power (in comparison to absence of the invention). During periods of high load, such as when the refrigeration storage containers are opened to store prepregs or remove prepregs from storage, any required refrigeration may be supplied by the invention and also by mechanical refrigeration units operated at relatively high power.

Second, the ambient atmosphere within the autoclave surrounding the heated molds may be purged with the gaseous cryogen produced by the invention. Purging the ambient atmosphere will decrease the concentration of oxygen in that ambient atmosphere and thus decreases any risk of combusting the carbon fibers during molding. Additional gaseous cryogen may be injected into the interior of the autoclave in case ambient air leaks into the autoclave.

Depending upon what the lower end of the range oxygen concentration in the ambient atmosphere is that will support combustion of the prepreg, the gaseous cryogen may even be mixed with an amount of air before purging the autoclave or injecting the cryogen into the autoclave during molding.

The invention yields many advantages. It may reduce or eliminate the electrical power demand of any mechanical freezers that are already at the installation, or for new installations, any mechanical freezers that would otherwise be expected to satisfy the cooling demand. It may even eliminate the necessity to have mechanical freezers at the installation. Because of the reduction or elimination of the need for mechanical refrigeration, the environmental and carbon footprint of chemical refrigerants such as ammonia and the heat and noise of the indoor mechanical freezers may be correspondingly reduced or eliminated. Much colder refrigeration temperatures are possible in comparison to the typical −10° F. (−23.3° C.) limit of mechanical freezers. Because of these much colder temperatures, the time (i.e., the temperature pull-down time) required for reaching a specified freezer temperature starting with an influx of warm air and/or warm items to be chilled may be shorted significantly.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur. Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method for supplying a flow of a gaseous cryogen from a source containing the cryogen in liquid form, said method comprising the steps of:
allowing a flow of air to a warm side of a heat exchanger located at an installation;
contemporaneous with said step of allowing a flow of air, allowing a first flow of a liquid cryogen from a liquid cryogen storage tank to a cold side of the heat exchanger, the liquid cryogen storage tank being located at the installation;
exchanging heat, at the heat exchanger, between the flow of the liquid cryogen and the flow of air to produce a first flow of vaporized cryogen and a flow of chilled air, respectively;
using the first flow of vaporized cryogen at a point of use that is located at the installation; and
providing refrigeration to a space, room or structure with the flow of cooled air, the space, room or structure being located at the installation.

2. The method of claim 1, further comprising the steps of:
allowing a second flow of the liquid cryogen from the liquid cryogen storage tank to a vaporizer;
exchanging heat, at the heat exchanger, between the second flow of the liquid cryogen and ambient air surrounding the vaporizer to produce a second flow of vaporized cryogen;
feeding the first flow of vaporized cryogen to an inlet of a compressor where it is compressed, the compressor being disposed in fluid communication between the heat exchanger and the point of use;
allowing a flow of the first flow of vaporized cryogen from an outlet of the compressor to a buffer tank disposed in fluid communication between the compressor and the point of use, wherein the point of use receives the first flow of vaporized cryogen from the buffer tank;
using the second flow of vaporized cryogen at the point of use, wherein:
when a demand for the vaporized cryogen by the point of use does not exceed a nominal flow rate, the gaseous cryogen of the first flow is accumulated in the buffer tank and is not used by the point of use, and
when a demand for the vaporized cryogen by the point of use exceeds a nominal flow rate, the first flow of the gaseous cryogen from the buffer tank is used by the point of use.

3. The method of claim 2, further comprising the step of providing refrigeration to the space, room or structure using a mechanical refrigeration unit located at the installation.

4. The method of claim 2, wherein the heat exchanger is disposed within the space, room or structure.

5. The method of claim 1, further comprising the step of providing refrigeration to the space, room or structure using a mechanical refrigeration unit located at the installation.

6. The method of claim 1, wherein the heat exchanger is disposed within the space, room or structure.

7. The method of claim 1, wherein the first flow of liquid cryogen is contained within vacuum jacketed piping and the flow of chilled air is contained in either foam insulated PVC piping, metal piping, or metal ducting.

8. An installation supplied with refrigeration and gaseous cryogen from vaporization of liquid cryogen, comprising:
a liquid cryogen storage tank containing liquid cryogen that is located at an installation;
a heat exchanger having a cold side in fluid communication with said storage tank and a warm side receiving a flow of air, said heat exchanger being located at the installation, said heat exchanger being adapted and configured to exchange heat between a flow of the liquid cryogen from the storage tank on the cold side and the flow of air on the warm side to produce a first flow of vaporized cryogen and a flow of chilled air, respectively;
a point of use, located at the installation, that is adapted and configured to us the first flow of vaporized cryogen; and
a space, room or structure located at the installation that is refrigerated with the flow of cooled air.

9. The installation of claim 8, further comprising:
a vaporizer receiving a second flow of the liquid cryogen from said storage tank, said vaporizer being adapted and configured to exchange heat between the second flow of the liquid cryogen and ambient air surrounding said vaporizer to produce a second flow of vaporized cryogen;
a compressor disposed in fluid communication between the heat exchanger and the point of use that is adapted and configured to receive and compress the first flow of vaporized cryogen; and
a buffer tank disposed in fluid communication between the compressor and the point of use that is adapted and configured to receive and store the compressed first flow of vaporized cryogen from said compressor, the point of use receiving the compressed first flow of vaporized cryogen from the buffer tank, wherein:
the point of use receives the second flow of vaporized cryogen;
when a demand for the vaporized cryogen by the point of use does not exceed a nominal flow rate, the gaseous cryogen of the first flow is accumulated in the buffer tank and is not used by the point of use, and
when a demand for the vaporized cryogen by the point of use exceeds a nominal flow rate, the first flow of the gaseous cryogen from the buffer tank is used by the point of use.

10. The installation of claim 9, further comprising a mechanical refrigeration unit located at the installation that provides refrigeration to the space, room or structure using.

11. The installation of claim 9, wherein said heat exchanger is disposed within the space, room or structure.

12. The installation of claim 8, further comprising a mechanical refrigeration unit located at the installation that provides refrigeration to the space, room or structure.

13. The system of claim 7, wherein said heat exchanger is disposed within the space, room or structure.

14. The system of claim 7, wherein the first flow of liquid cryogen is contained within vacuum jacketed piping and the flow of chilled air is contained in either foam insulated PVC piping, metal piping, or metal ducting.
